(19) United States
(12) Patent Application Publication
(10) Pub. No.: US 2013/0144718 A1
(43) Pub. Date: Jun. 6, 2013

(54) Integrated system for gathering commerce information and distributing advertising using a global computer network

(71) Applicant: Jeff Myers, Phoenix, AZ (US)

(72) Inventor: Jeff Myers, Phoenix, AZ (US)

(21) Appl. No.: 13/694,543

(22) Filed: Dec. 12, 2012

Related U.S. Application Data
(63) Continuation of application No. 09/860,196, filed on May 17, 2001.

(51) Int. Cl. G06Q 30/02

(52) U.S. Cl. CPC G06Q 30/0255
USPC 705/14.53; 705/14.65

(57) ABSTRACT

A system gathers commerce information and distributes advertising using an integrated global computer system. The integrated system includes a local area network (LAN) in retail stores that interconnects cash registers in the stores. The LAN is also interconnected with electronic billboards that are mounted to the checkout aisles near the cash registers. Sales data is registered by each cash register, recorded as a customer record, and electronically transferred to a main server connected to the LAN. Periodically, this main server uploads this sales data to a central data server through using a global computer network. Based upon the customer purchase information stored in this central data server, it is possible to purchase advertising. The purchased advertisements are transmitted to the individual stores through the global computer network and shown on electronic billboards that are fixed to the checkout aisles in retail stores.

### PRIORITY CLAIMED

This application is a continuation of U.S. Ser. No. 09/860,196 filed May 17, 2001.

### FIELD OF THE INVENTION

The present invention relates to the field of electronic commerce systems supported by a global computer network. More specifically, the present invention relates to an integrated system for gathering commerce information and distributing advertising using a global computer network in order to improve and enhance the efficiency of commerce in retail stores.

### BACKGROUND

Consumer retail stores are continuously searching for new systems to improve efficiency, increase product sales, and enhance consumer satisfaction. One problem facing retail stores is long lines of consumers at the checkout counter. During peak shopping hours lines will form at the cash register as consumers wait to purchase their shopping items. In long lines, consumers can become angry and impatient. Currently, stores typically cope with the problem of long lines through adding more cash registers and clerks to handle the increase consumer load. Failing to address this problem can result in lost sales.

One method of dealing with consumer impatience in the checkout line is to provide some sort of entertainment to the consumer. Through adding video display screens to checkout lanes, consumers can have an entertaining video display to watch while they wait to reach the cash register. The addition of a video display will distract consumers while waiting in line will mitigate their anger and impatience at the long line. Through adding video displays that will mitigate consumer anger and impatience, retail stores can operate with fewer checkout lanes.

Another problem facing retail stores is a lack of consumer knowledge. The main way consumers are made aware of new products and product improvements is through commercial advertising. At present, the overwhelming majority of advertising occurs outside of retail stores such as television, radio, and roadside billboard advertising. The problem with this form of advertising is that consumers do not have the ability to immediately purchase the products once he or she sees the advertisement because they are typically not in a store. Frequently, by the time the consumer reaches the store, he or she would have forgotten about the advertisement and the product. However, when a consumer is in a retail store, he or she can purchase the products immediately that they see on in-store advertising. Therefore, providing in-store advertising is likely to enhance product sales.

A still further problem involving advertising lies in which products to advertising. Products with high consumer recognition and high sales typically a certain amount of advertising to maintain those sales. However, products with low consumer recognition and low sales typically require far higher amounts of advertising to boost sales. There is a need for an efficient system whereby companies could gather real time sales data on its products and allocate advertisements directly in the retail stores as needed to maintain or boost product sales.

### SUMMARY OF THE INVENTION

The present invention is an integrated system for gathering commerce information and distributing advertising using a global computer network in order to improve and enhance the efficiency of commerce in retail stores. The first component of this integrated system is a local area network (LAN) in retail stores that interconnects all of the cash registers. Each customer at the store is offered a customer purchasing card that contains an identification number that is unique to that customer. When the customers makes a purchase at the store, the customer will first enter his or her customer purchasing card into the cash register. The cash register will make a record of all products purchased by the customer and record the information under a customer purchase record. All customer records are identified by the customer's unique identification number.

The LAN that interconnects each cash register is also interconnected to an array of electronic billboards that are mounted to the checkout aisles near the cash registers. Sales data is registered by the cash register, recorded as a customer record, and electronically transferred to a main server connected to the LAN. Periodically, this main server uploads this sales data to a central data server through using a global computer network. The central data server then stores the individual customer purchase record in the customer purchase database.

A company can view the sales performance of its products through accessing a web-site supported by the same global computer network. This web-site is directly connected to the central data sever. Through accessing this web-site, the company can viewing the sales performance data of its products stored on the central data server. Based upon this sales data, the company may wish to purchase advertising to maintain or increase the sales of its products. The company can therefore purchase advertising to through the same web-site through accessing the advertising purchase system.

The advertising that the company is purchasing through the advertising purchase system is shown on electronic billboards that are fixed to the checkout aisles in retail stores. In the advertising purchase system, companies can select specific stores and specific times during which to advertise.

When purchasing the advertisement for a specific product, the company specifies a product profile. The product profile is a listing of products that would show a customer's probable interest in purchasing the specified product that the advertisement is purchased for. For instance, if the company wanted to sell barbecue sauce, the product profile would include complimentary products such as steaks, hamburger meat, hot dogs, hamburger and hot dog buns, as well as potentially other barbecue sauces. Customers that purchase steaks, hamburger meat, and hot dogs are probably highly interested in purchasing barbecue sauce. The product profile is used by this integrated system for determining which advertisements are to be shown to which customers. The product profiles are stored in the purchase advertising database.

The electronic billboards are comprised of a changeable display of alphanumeric characters, on a flexible sheet of plastic transistors, and a video display. The video display can either be a plasma display, liquid crystal display, or cathode ray tube display. The changeable display of alphanumeric characters on the flexible sheet of plastic transistors and the video display are connected to the main sever in the store. Through displaying entertaining and informative advertisements to consumers while they are waiting in checkout aisles, the consumers will be distracted from their long wait thereby enhancing consumer satisfaction. Also, consumers through aisle mounted electronic billboards receive information on products at the place where they can buy the products immediately thereby increasing product sales.

From the same web-site, the company can create either a still image advertisement or a video advertisement and upload it to the advertising server through the web-site. The advertising server then transmits these advertisements to the main server at the store or stores that the company selected. Along with these advertisements, the associated product profiles are also transmitted to the stores computer system.

When a customer goes to the cash register to make a purchase, he or she first enters his or her customer purchase card. The cash register then passes the information to the store's main server that then accesses the customers purchase record stored on the customer purchase database. The store's main server then accesses the product profiles transmitted to the store and compares them to the customer purchase records. The main server at the individual stores then selects and displays advertisements that have product profiles that match the customer purchase records on the electronic billboards at the times selected by the company.

A primary object of the invention is to provide an integrated system whereby companies can gather real time data on product sales over a global computer network and develop, purchase, and transmit advertising over the same network.

A further object of the invention is to provide a method of advertising to consumers in the checkout aisles of retail stores. A still further object of the invention is to provide a method of entertaining consumers while they are in the checkout aisles. Another object of the invention is to enhance commercial efficiency of retail stores.

Further objects and advantages of the invention will become apparent as the following description proceeds and the features of novelty which characterize this invention are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings wherein:

FIG. 1 shows a block diagram of the integrated system for gathering commerce information and distributing advertising using a global computer network;

FIG. 2 shows a perspective view of a retail store check out counter that includes an electronic billboard;

FIG. 3 shows a block diagram of the systems comprising the management system supported by a web-site on a global computer network;

FIG. 4 shows the process of logging in and registering a user;

FIG. 5 shows the process for searching for available advertising space;

FIG. 6 shows the process for buying an advertisement;

FIG. 7 shows the process for creating an advertisement;

FIG. 8 shows the process for uploading an advertisement and distributing it to the network of electronic billboards;

FIG. 9 shows a user/registration database;

FIG. 10 shows an electronic billboard database;

FIG. 11 shows an information bearing cartridge;

FIG. 12 shows an information bearing storage medium for the microcode used in processing the activity of the electronic billboard management system;

FIG. 13 shows an information bearing semiconductor chip;

FIG. 14 shows a commerce sales database;

FIG. 15 shows a products sales database;

FIG. 16 shows perspective view of a changeable display of alphanumeric characters on a flexible sheet of plastic transistors;

FIG. 17 shows a sectional view of a changeable display of alphanumeric characters on a flexible page of plastic transistors;

FIG. 18A shows the process of selecting an advertisement to display;

FIG. 18B shows the process of selecting an advertisement to display;

FIG. 19 shows a product profile table; and

FIG. 20 shows a customer purchase record.

### DESCRIPTION OF THE PREFERRED EMBODIMENTS

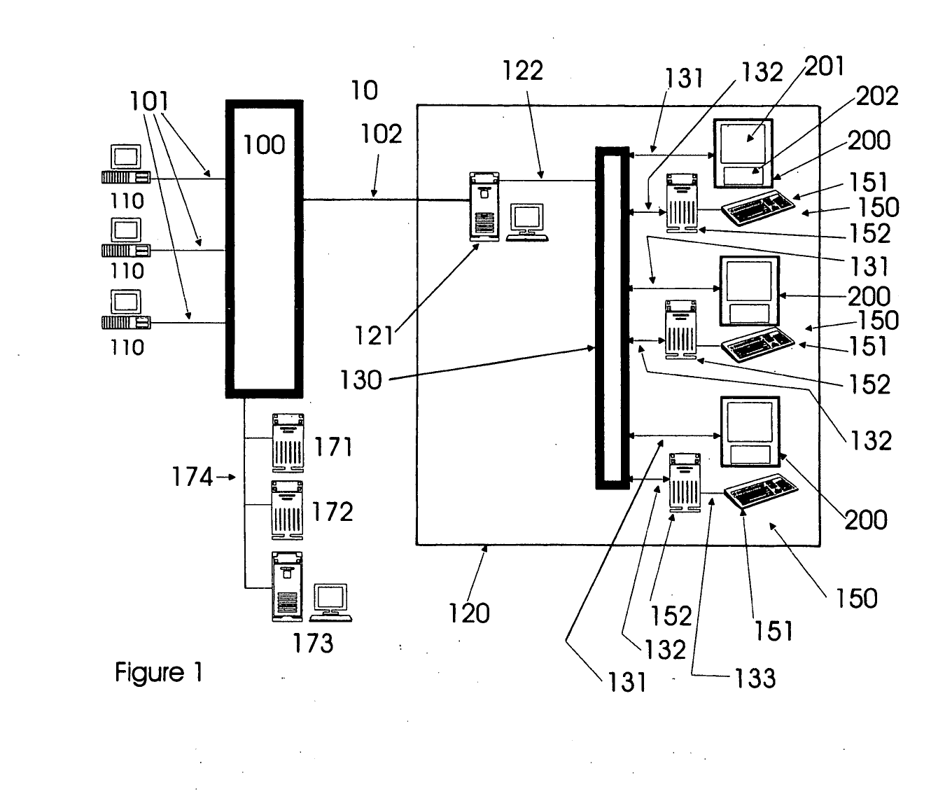

Referring to the Figures by characters of reference, FIG. 1 shows a block diagram of the integrated system 10 for gathering commerce information and distributing advertising using a global computer network. A series of electronic billboards 200 are electronically connected to a central bus 130. Each electronic billboard 200 includes a video display 201 and a still image electronic display 202. In addition, a plurality of electronic cash registers 150 that are made of a keyboard 151 and a computer 152 are also connected to the bus 130. Keyboard 151 is connected to computer 152 via cable 133. The electronic cash registers 150 include a credit card reading device that is capable of reading information stored on the magnetic strip of a common credit card. A customer is also provided with a customer purchase card that is a plastic identification card that has a magnetic strip mounted to the back portion of the customer purchase card similar to a common credit card. The magnetic strip stores the customer's unique shopping identification number. The electronic billboards 200 and cash registers 150 are connected to bus 130 through connections 131 and 132 respectively. The bus 130 connects the cash registers 150 and electronic billboards 200 to a main server 121 through connection 122. The main server 122 is connected to a global computer network 100 by connection 102. Connections 131, 132, 122, and 102 may be coaxial cable, fiber optic cable, IEEE-1394 fire-wire, or wireless.

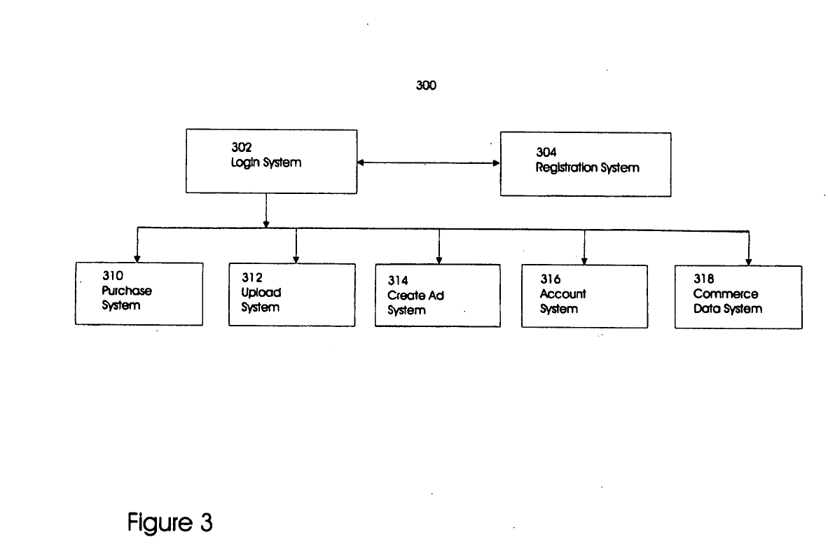

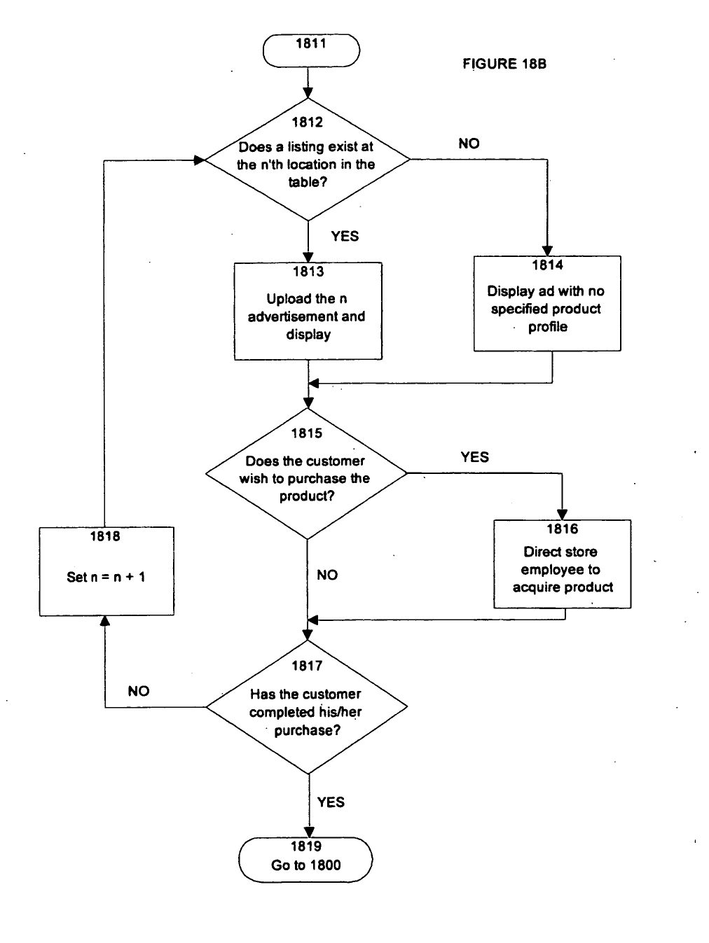

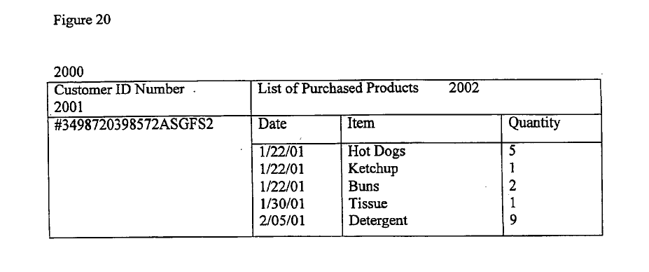

During a sale, the customer will approach the cash registers 150 with the products he or she physically selected from the shopping aisles and wishes to purchase. The customer will then enter his or her customer purchase card into the cash register 150. The cash registers 150 gathers the sales data from the customer's product purchases and compiles the sales data into a customer purchase record 2000 shown in FIG. 20. The customer purchase record 2000 is identified by the unique customer identification number contained on the customer purchase card. The customer purchase record 2000 is comprised of a section 2001 that contains the customer identification number and a table 2002 that lists the products purchased by the customer and the dates upon which he or she bought them. The cash registers 150 then transfer this customer purchase record 2000 to the main server 121 through bus 130. The main server 121 uploads this sales data to a commerce data server 171 that stores all sales data in a customer purchase database. Users that are connected to the global computer network 100 through their own personal computers 110 and modem connections 101 can access a web-site 300, shown in FIG. 3. Through web-site 300, the user can access the sales data stored on the commerce data server 171. In response to this sales information the user can access the advertising server 172. An upload database and a price database are also maintained on server 171 or 172. The user can upload advertisements through the global computer network 100 to the advertising server 171. The advertising server then transmits these advertisements to the main server 121 located at a store 120, represented by a dashed square. The store 120 encompasses all of the cash registers 150 and billboards 200. While FIG. 1 only shows one store 120, the system is intended to function with numerous stores connected to servers 171 and 172 through the global computer network 100. A web-server computer 173 is connected to servers 171 and 172 through connection 174 to permit access and maintenance on the servers 171 and 172. Once the advertisement is downloaded to the main server 121, the main server displays the advertisement pursuant to the process identified in FIGS. 18A and 18B on the electronic billboards 200 through bus 130.

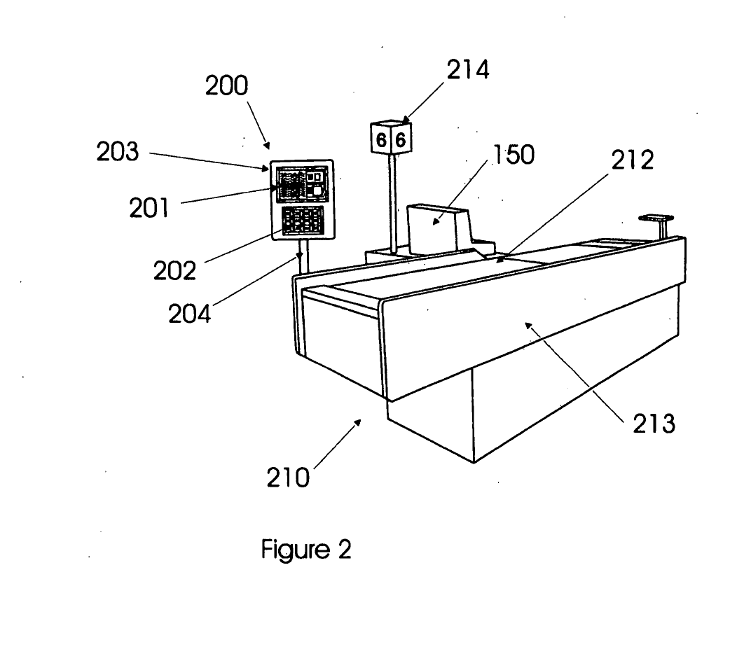

FIG. 2 shows a perspective view of a retail store checkout counter 210 that includes an electronic billboard 200. The electronic billboard 200 is comprised of a hard case 203 that is supported by a post 204. Post 204 is secured to the check out counter 210. A video display 201 and a still image display 202 are contained within case 203. Visual output of the video advertisement is seen on display 201. Display 201 could preferably be a gas-discharge display, which is commonly known as a plasma display. A gas-discharge display contains neon between a horizontal and vertical set of electrodes. When a vertical and a horizontal electrode are charged, the neon glows at their intersection, emitting light. Display 201 may equally be a cathode ray tube (CRT) commonly used with desktop computers, a liquid crystal display, light emitting diode display, or a flat panel electroluminescent display. That these displays 201 have a touchscreen capability is highly desirable.

Display 201 may be a liquid crystal display (LCD) commonly used in laptops, cell-phones, fax machines, etc. An LCD display uses organic fluids called liquid crystals, because liquid crystals possess two important properties. First, liquid crystals are transparent but can alter the orientation of polarized light passing through them. Second, the alignment of liquid crystal molecules and their polarization properties can be changed by applying an electric field. Liquid crystals are sandwiched between two glass plates, the outsides of which having been coated with polarizing filters and the inner plate is typically backlit via fluorescent light. Inside these glass plates is a matrix of electrodes. When an element of the matrix, called a pixel, experiences a voltage change, the polarization of the adjacent liquid crystal molecules change, which alters the light transmitted through the LCD pixel and hence seen by the user.

Display 201 could equally use light emitting diodes (LEDs) which are a semiconductor device that converts electrical energy into light. LEDs work on the principle of electroluminescence and are produce little heat for an amount of light output. Display 201 could be a flat panel electroluminescent display, where a thin phosphor layer is set between vertical and horizontal electrodes. These electrodes form an X-Y Cartesian coordinate system. When a vertical and a horizontal electrode are charged, the phosphor at their intersection emits light.

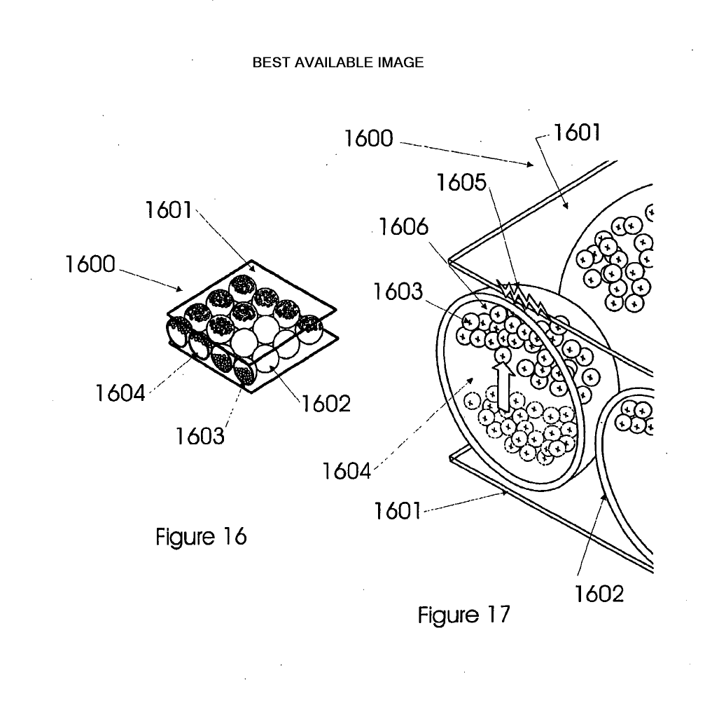

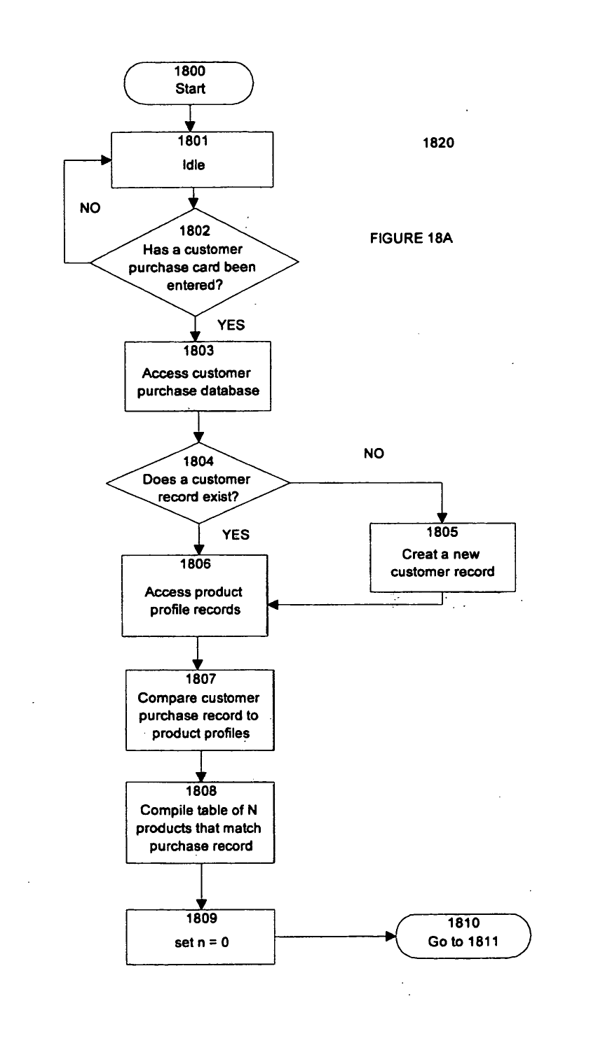

The still image alphanumeric advertisement is displayed on display 202. Display 202 is preferably a changeable display of alphanumeric characters on a flexible page of plastic transistors. FIGS. 16 and 17 show perspective views of the changeable display 1600 of alphanumeric characters on a flexible sheet of plastic transistors 1601. This changeable display 1600 consists of a liquid ink 1604 that contains millions of tiny spheres 1602 sandwiched between thin layers of electrode-laden material 1601. Each sphere 1602, called a microcapsule, carries tiny white pigment chips 1603 suspended in blue fluid 1604. When an electrical charge 1605 is applied, the chips 1603 either float to the top 1606 to create a white surface, or sink beneath to let the liquid ink 1604 dominate. Liquid ink 1604 is typically a blue dye. Letters and numbers are formed on the display by changing the charge under particular spheres. This changeable display 1600 is commonly referred to as “E INK.”

Referring again to FIG. 2, the electronic billboard 200 is mounted to the checkout counter 210 where consumers standing in line can view the displays 201 and 202. The checkout counter 210 includes a conveyor belt 212, a base 213, a cash register 150, and an aisle identifier 214. The cash register 150 includes a device for reading conventional credit cards and customer purchase cards.

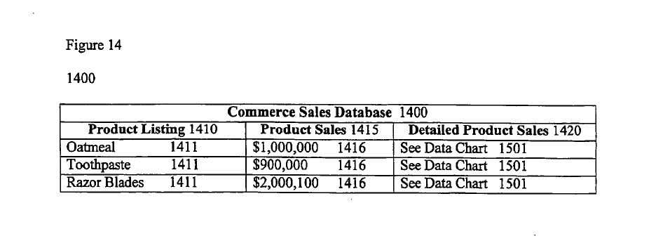

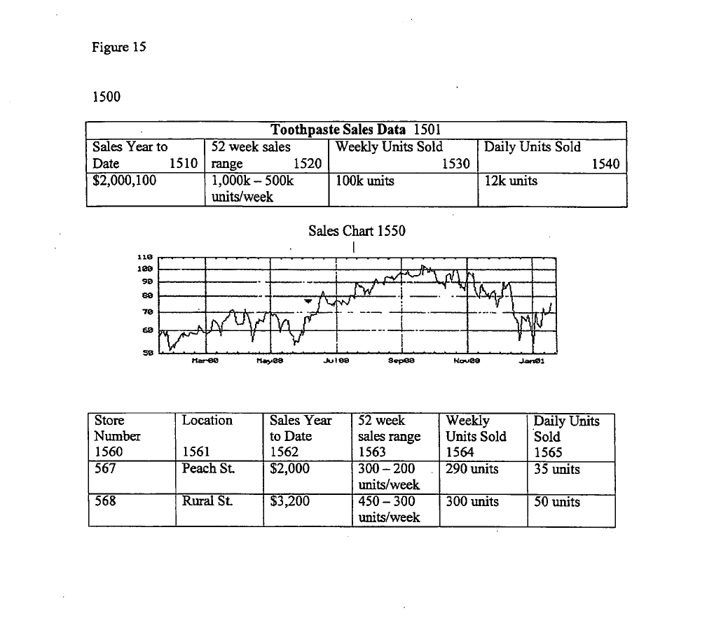

FIG. 3 shows architecture menu 300. Architecture menu 300 comprises login system 302. If a prospective user is not yet registered, there is registration system 304. Once the user is registered, the user has access to purchase system 310, upload system 312, create ad system 314, account system 316, and Commerce Data System 318. Under the Commerce Data System 318, further described in FIGS. 14 and 15, the user can view all of the sales data gathered by all of the cash registers 150 located in all of the stores that are connected to the commerce data system 318. Based upon this sales data, the user can select which stores he or she wishes to advertise in to maintain or increase the sales performance of his or her products. Through the buying, creating, and distributing advertisements through the use of the purchase system 310, upload system 312, and create ad system 314, the user can increase product sales. In the event that a purchaser has not already produced an advertisement to show on a display 201, the purchaser can create a video or still image advertisement using the create ad system 314. The create ad system 314 is comprised of a Corel photo-paint or similar software system that produces animated and still drawings. The purchaser can access the account system 316 to examine the financial activity on their account. The purchaser can view how many billboards she has purchased and at what price. The purchaser can also update their contact information such as phone, fax, mailing address, and email address. The purchaser can also update their billing information or credit card information through the account system 316.

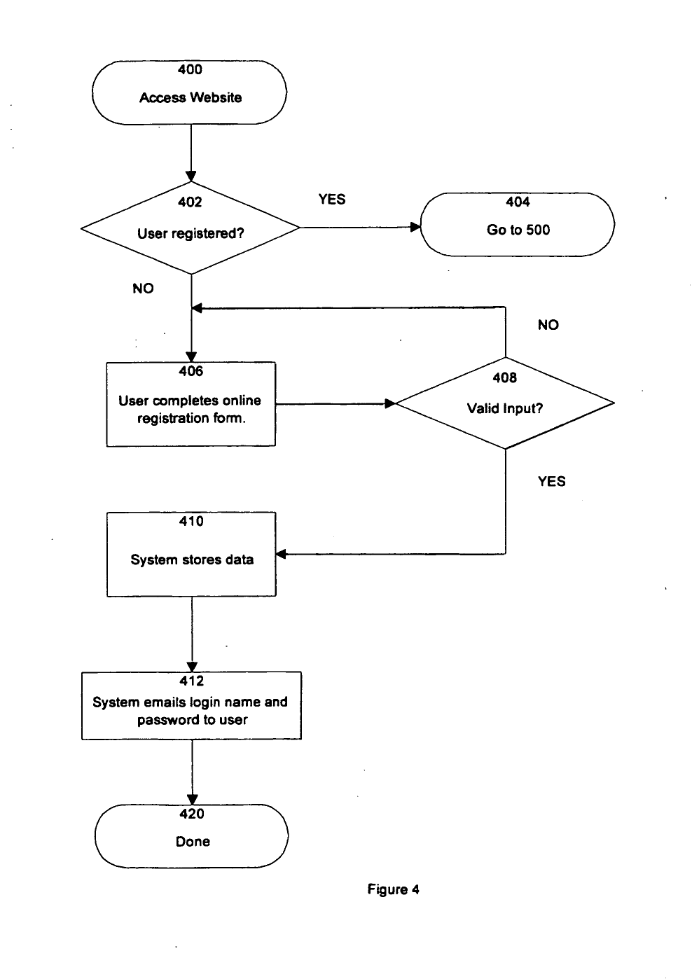

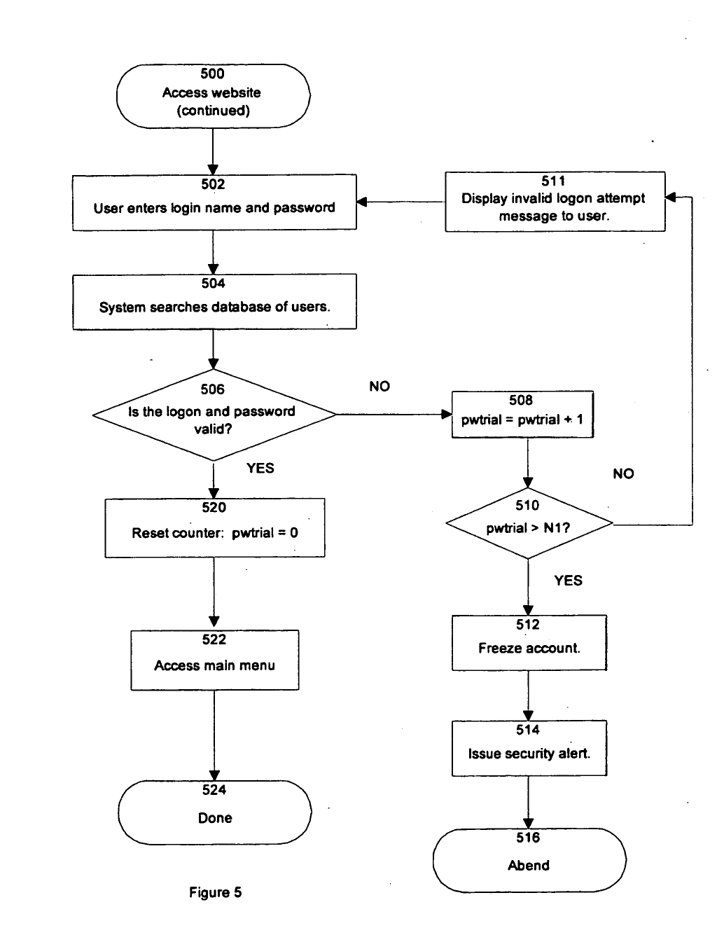

Login system 302 and registration system 304 are further developed in FIGS. 4 and 5. When a user accesses the website, step 400, step 402 is used to determine whether the user is already registered. If the user is already registered, the process flows to step 404, which sends the process to step 500 in FIG. 5.

However, if the user is not already registered in step 402, the registration process flows to step 406, where the user completes an online registration form. The registration process then flows to step 408, where the input provided by the prospective user is checked. If the input is not valid, due to invalid email address, nonexistent credit card information, etc., step 408 returns to step 406 and the user is again asked to complete the online registration form. However, if the input is verified as valid in step 408, the registration process flows to step 410 where the system stores the data for future use. Then the registration process flows to step 412, where the system emails a logon name and password to the user via the email address supplied by the user. Then the registration process ends at step 420.

In FIG. 5, the user enters his or her logon and password in step 502. In step 504, the system searches the database of users in registration system 304. From step 504, the logon process flows to step 506, where the system checks as to whether the logon and password are valid. If the logon and password are not valid, the logon process flows to step 508, where the counter of the number of logon attempts is incremented by one, pwtrial=pwtrial+1. In step 510, the counter pwtrial is compared against a threshold number N1. This threshold number could be set by the system administrator. A suitable value for N1 could be three. If the counter does not exceed this threshold number N1 in step 510, the logon process flows to step 511, where the user receives an “Invalid logon and password” message. Then, the process goes back to step 502 for another logon attempt.

However, if the counter of the number of logon attempts exceeds threshold Ni in step 510, the logon process flows to step 512 and the account is frozen for security reasons. This is to prevent hackers from causing harm. The logon process flows to step 514, where a security alert is issued to the system administrator before the logon process “abnormally ends” or abends in step 516.

If the user provides a valid logon and password in step 506, the logon process flows to step 520, where the counter of the number of logon attempts is reset to zero, pwtrial=0. Then the logon process flows to step 522 where the user is given access to the main menu, which was described in FIG. 3. The logon process flows to step 524, signifying that the logon process is now complete.

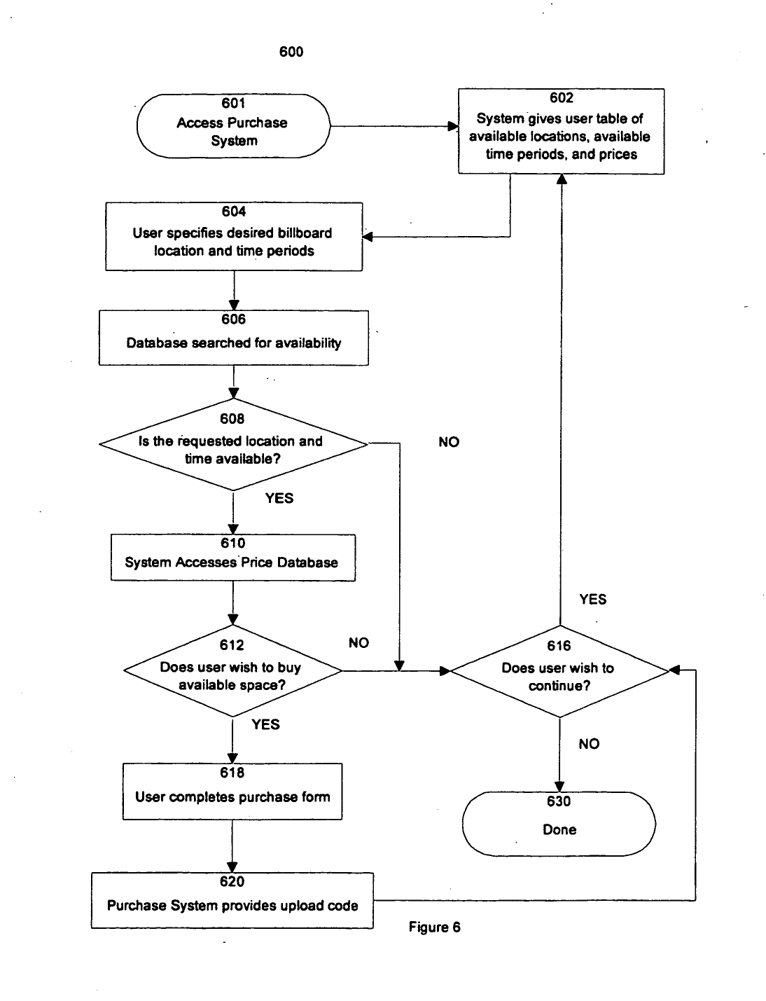

Once the logon process is completed, FIG. 5, the user may enter the access purchase system process 600 at step 601 of FIG. 6. The purchase process flows to step 602, where the system gives the user a table of available locations, available time periods or slots, and the prices associated with those locations and time periods. The purchase process then flows to step 604, where the user specified the desired billboard location and time periods. The purchase process then flows to step 606, where the purchase process searches the database for the availability of the desired billboard location and time periods. In step 608, the query is made as to whether the requested location and time is available. If the requested location and time is not available, the purchase process flows to step 616, where the user is queried if he or she desires to continue with the purchase process. If the user does wish to continue with the purchase process in step 616, the process flows to step 602. If the user does not wish to continue with the purchase process in step 616, the purchase process exits at step 630.

If in step 608, the requested location and time is available, the purchase process flows to step 610, where the purchase process accesses the price database. Then the purchase process flows to step 612, where the user is asked whether he or she wishes to purchase the available location and time. If the user answers no, the purchase process flows to step 616. However, if the user does wish to purchase the location and time, the process flows to step 618 and the user then completes an online purchase form. The purchase process then flows to step 620, where the user is provided with an upload code, for uploading his or her advertisement. Then, the purchase process flows back to step 616, where the user is queried whether he or she wishes to continue and possibly make additional purchases.

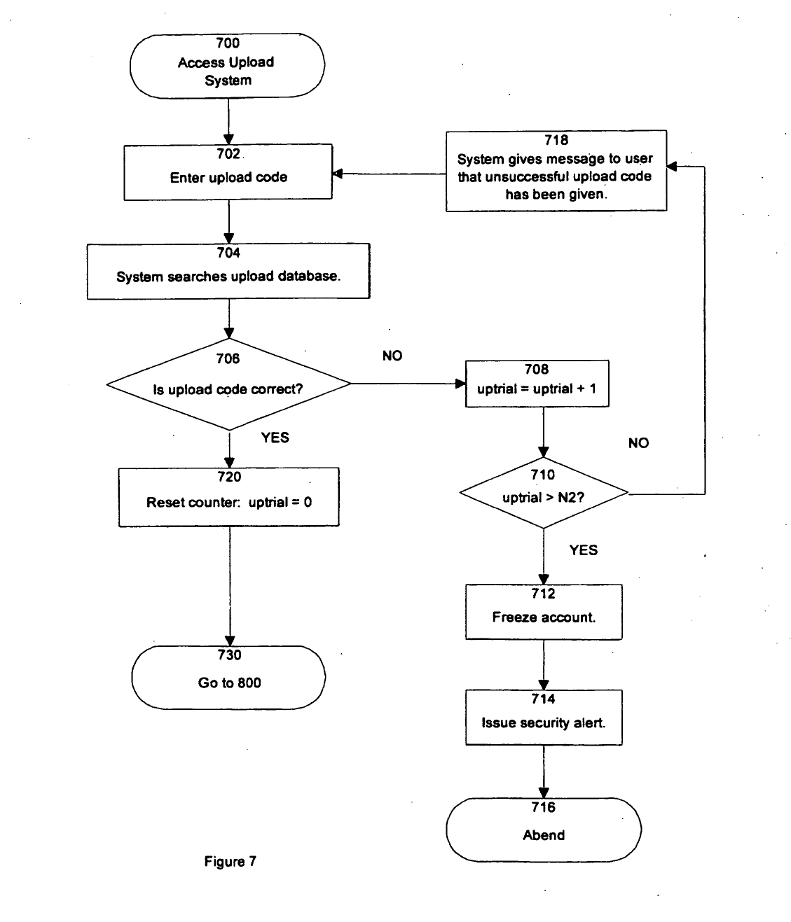

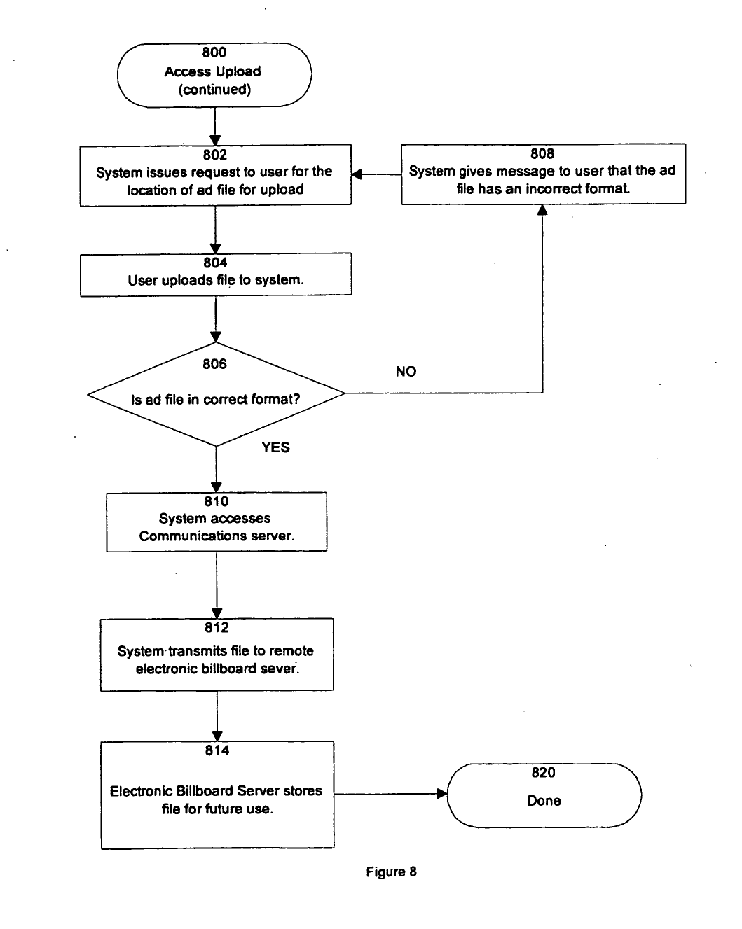

In FIG. 7, the user prepares to upload advertising in step 700. The upload process flows to step 702, where the user provides the upload code from step 620 of FIG. 6. The upload process flows to step 704, where the system searches the upload database in an attempt to check the validity of the upload code. If the upload code is correct, the upload process flows to step 720, where the counter for attempts to enter the upload code is reset to zero, uptrial=0. Then the upload process flows to step 730, which signifies a jump to step 800 of FIG. 8.

If the upload code is not correct in step 706, the logon process flows to step 708, where the counter of the number of upload code attempts is incremented by one, uptrial=uptrial+1. In step 710, the counter uptrial is compared against a threshold number N2. This threshold number could be set by the system administrator. A suitable value for N2 could be three. If the counter does not exceed this threshold number N2 in step 710, the logon process flows to step 718, where the user receives an “Invalid upload code” message. Then, the process goes back to step 702 for another logon attempt.

However, if the counter of the number of upload code attempts exceeds threshold N2 in step 710, the logon process flows to step 712 and the account is frozen for security reasons. This is to prevent hackers from causing harm. The logon process flows to step 714, where a security alert is issued to the system administrator before the logon process “abnormally ends” or abends in step 716.

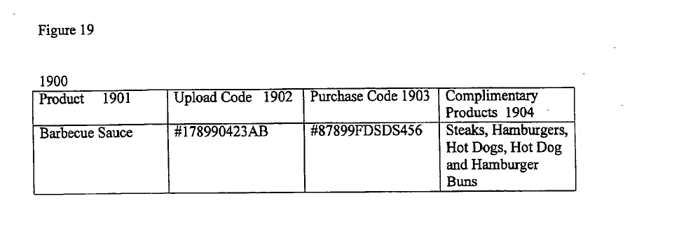

FIG. 8 gives the rest of the upload process, which begins with step 800, which the user reaches upon correctly entering his or her upload code. The upload process then continues to step 802, where the system issues a request to the user for the location of the advertisement file for upload. The upload process flows to step 804, where the user provides the location of the file to be uploaded and the file is uploaded to the system. The file to be uploaded includes a digital video advertisement and a product profile table 1900 shown in FIG. 19. The product profile table 1900 is a listing of products that would indicate that a customer would probably wish to purchase the product that is the subject of the purchased advertisement. The upload process then flows to step 806, where the system performs a check of the advertisement file, to insure it is in the correct format and compatible with the display technology which will display the file. If the advertisement file is not correct in step 806, the upload process flows to step 808, where an “Improper Format” message is displayed to the user. Then the upload process flows from step 808 to step 802 where the user can upload a correct advertising file.

If the advertising file is in the correct format in step 806, the upload process flows to step 810, where the system accesses the communications server. The upload process then flows to step 812, where the system transmits the advertisement file to one or more electronic billboards 200. Then upload process then flows to step 814, where the advertisement file is stored on the electronic billboard server at the desired. The upload process then flows to step 820, which is the conclusion of the upload process.

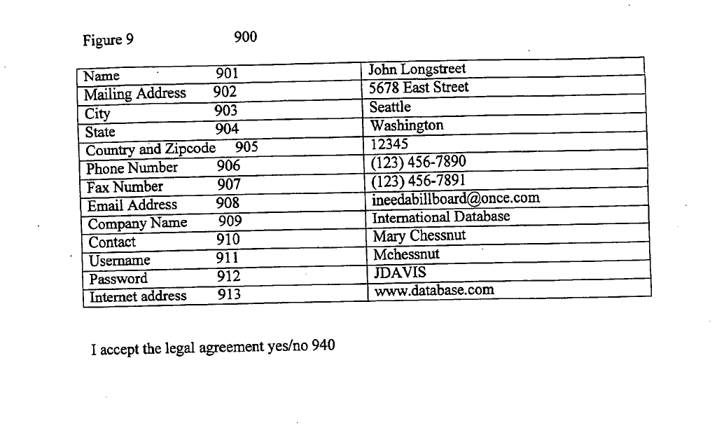

FIG. 9 shows a user/registration database 900. Template 900 includes the contact person's name 901, mailing address 902, city 903, state 904, country and Zip code 905, phone number 906, fax number 907, email address 908, and company name 909, name of contact 910, username 911, password 912, and Internet address 913. A purchaser seeking to register as a user on the system will provide information for 901, 902, 903, 904, 905, 906, 907, 908, 909, 910, and 913. The registration system 304 generates the username 911 and the password 912 and stores them in the table 900. The registration system emails the username 911 and the password 912 to the purchaser at the email address 908. Optional agreement with any legal agreements associated with the integrated system is shown at 940.

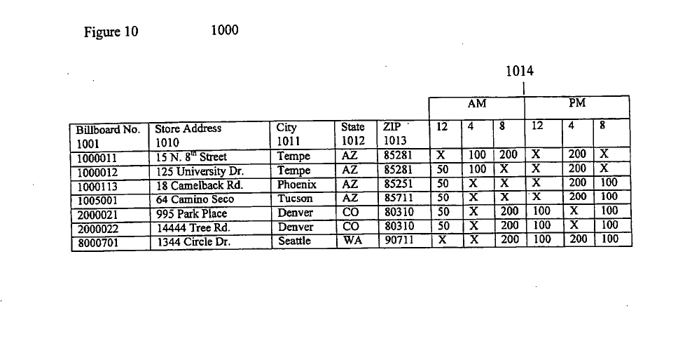

FIG. 10 shows an electronic billboard database 1000. The database 1000 provides a listing of all of the electronic billboards 200 in the network by their billboard number 1001, the street address of the store 1010, city 1011, state 1012, and zip code 1013. The purchase system 310 uses the information 1001, 1010, 1011, 1012, and 1013 to generate a map showing the locations of billboards 200 available for purchase. Section 1014 provides a table of the times and prices of the billboards 200. The billboards in this table are shown being for sale in four hour blocks of time at 12 am, 4 am, 8 am, 12 pm, 4 pm, and 8 pm. An “X” in a time block indicates that the billboard 200 has already been purchased. A number in the time block indicates the price at which that four hour time block for that billboard 200 can be purchased. If the purchaser buys a block of time, the purchase system 314 writes an “X” in the table for every block of time purchased. While this table is shown dividing the available electronic billboard space into four hour blocks of time, any time increment is possible.

FIG. 14 shows a commerce sales database 1400. The table 1400 provides a listing 1410 of all of the products 1411 that are designated under the user's account. A listing 1415 of the total sales revenue 1416 is provided for each product 1411. A more complete sales data base 1500 is provided under listing 1420 by clicking on the link 1501 entitled “see Data Chart” in the table 1400.

The product profile table. 1900 provides the listing of products that would indicate that the customer would probably wish to purchase the product that is the subject of the purchased advertisement is shown in FIG. 19. For instance, if the advertisement is for barbecue sauce, the product profile 1900 would include a listing of complimentary products 1904 such as steaks, ribs, hot dogs, ground hamburger meat, hot dog and hamburger buns. If the customer purchased these complimentary products, it is highly probable that the customer would be receptive to seeing an advertisement about barbecue sauce. The product profile table 1900 is comprised of a first column 1901 listing the product that is contained in the advertisement, a second column 1902 listing the upload code for the advertisement, a third column 1903 listing the purchase code for the advertisement, and a fourth column 1904 listing the complimentary products that the customer might purchase. The product profile table 1900 is used by this advertising system to selectively target specific advertisements to specific customers to enhance the ability to sell the product.

FIG. 15 shows a product sales database 1500. The database 1500 provides a listing of total product sales year to date 1510, the 52 week sales range 1520, weekly units sold 1530, daily units sold 1540, and a sales chart 1550 for toothpaste 1501. In addition, the database 1500 includes a listing of the stores 1560, store locations 1561, sales year to date at each individual store 1562, 52 week sales range 1563 weekly units sold at each store 1564, as well as daily units sold at each store 1565. Through viewing this detailed database 1500, the user can select which stores 1560 he or she wishes to purchase electronic billboard 200 advertising time at to promote his or her products at retail store checkout counters 210.

The process for selectively targeting the display of specific advertisements to specific customers is shown in FIGS. 18A and 18B. The advertising system starts the selecting and displaying advertising routine 1820 at step 1800. The system remains at an idle stage 1801 until a customer enters his or her customer purchase card. When a customer goes to the cash register 150 to make a purchase, he or she first enters his or her customer purchase card into the cash register 150. In process 1802, the system determines if the customer has entered his or her product purchase card. If the customer has entered his or her product purchase card, the process flows to step 1803. In step 1803, the system accesses the customer purchase database, which is shown in FIG. 20, that is comprised of all of the customer purchase records 2000 for all of the customers. Customers are identified via customer ID 2001, which is read from the magnetic strip of the customer's purchase card. The system then searches to determine if a previous customer purchase record 2000 exists in step 1804. If a previous record 2000 does not exist, the system flows to step 1805 where a new record is created and proceeds to step 1806. If a previous record 2000 does exist, the system also proceeds to step 1806. In step 1806, the system accesses the product profile records 1900 stored on the electronic billboard server. The system compares the product profiles to the accessed customer purchase record in step 1807. In step 1808, the system compiles a table of N products that have product profiles that match the listing of purchases 2002 contained in the customer record 2000. A counter of count n is set to zero in step 1809. This counter is used to increment through the table generated in step 1808. The process then flows to step 1810 and then to step 1811. At step 1812, the system determines if a listing exists at the zero location in the table generated by step 1808. If no such listing exists, the process flows to step 1814 where the system displays an advertisement on the electronic billboard 200 that has a generic product profile 1900. A generic product profile 1900 is one where the company purchasing the advertisement directed that this ad should be shown to any customer regardless of the customer's purchase record 2000.

If a listing does exist at the n location in the table generated by step 1808, the system uploads and displays this ad on the electronic billboard 200 in step 1813. In step 1815, the customer is asked if he or she wishes to purchase the product. The credit card device included with the cash register 150 includes a “YES” button and a “NO” button where the customer may accept or reject the transaction. Alternately, display 201 may be a touch screen display and the user merely touches “YES” or “NO.” In determining whether to accept the purchase of the product shown in the advertisement in step 1815, the customer would push either the “YES” or the “NO” button. If the customer selected “YES,” the process flows to step 1816 where the system directs a store employee to get the product so that the customer does not have to get out of line. In addition, the cost of the product is automatically added to the customer's bill.

The process the flows to step 1817 after step 1816 or if the customer rejects the option to purchase the product in step 1815. In step 1817, the system determines if the customer has completed his or her purchase. If the answer is yes, the process flows to step 1800 where the system goes back into an idle phase in step 1801. However, if the customer has not completed his or her transaction yet, the process flows to step 1818 where the system increments the counter n and returns to step 1812. The step 1818 increments down the list of advertisements to show the next advertisement to the customer. However, if the customer has completed his or her transaction and leaves the cash register 150, the system returns to an idle phase in step 1801 so as not to show advertisements to an empty checkout isle.

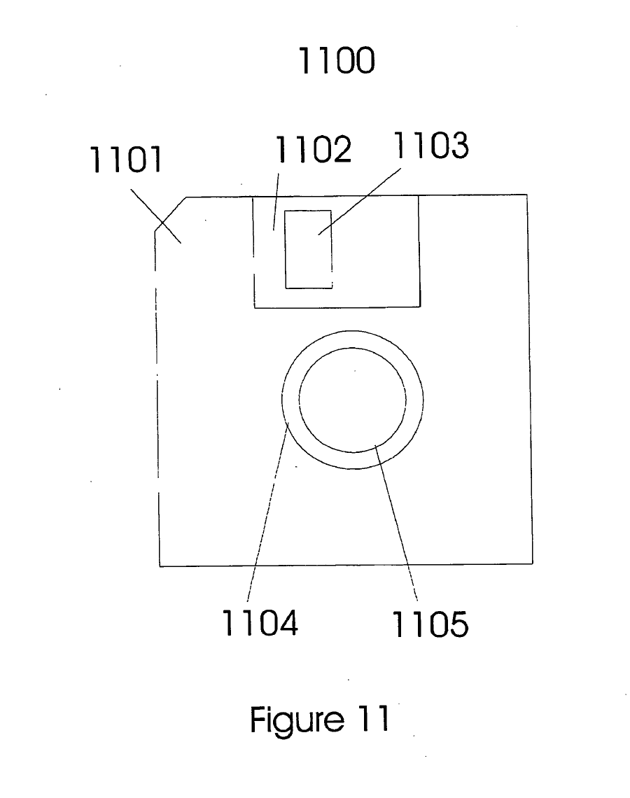

FIG. 11 shows a typical floppy disk cartridge 1100 which could be used hold the microcode used in processing the activity of the electronic billboard management system. Floppy disk cartridge 1100 consists of cartridge body 1101 and shutter 1102. Shutter 1102 has an opening 1103, so that I/O can be performed on the data on disk inside of the cartridge body 1101. Cartridge body 1101 has an opening 1104 so that the hub 1105 of the floppy disk can be rotated by a floppy disk drive, for the purposes of I/O.

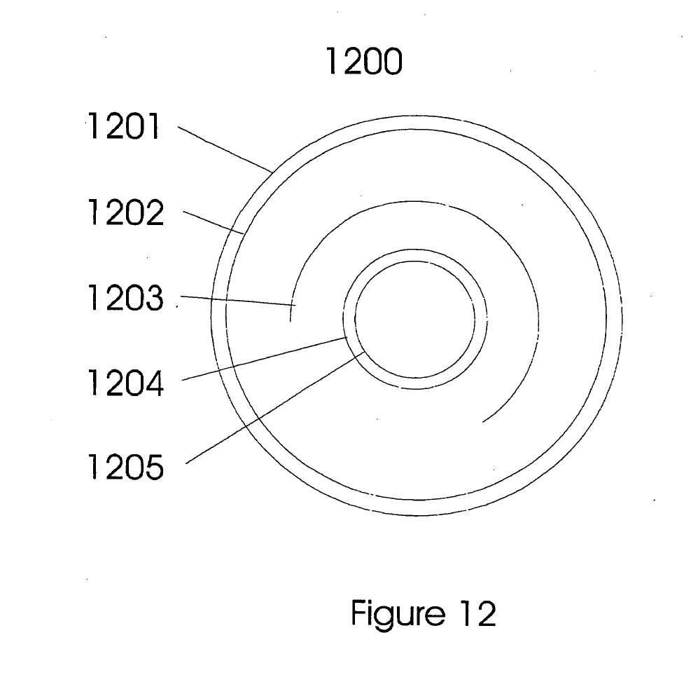

FIG. 12 shows a typical floppy disk 1200 which would be contained in floppy disk cartridge 1100. Floppy disk 1200 has an circular outer perimeter 1201. Data is recorded in circular or spiral tracks 1203 between the inner recording radius 1204 and the outer recording radius 1202. Hub 1205 is used to rotate the floppy disk 1200 so that I/O can be performed on the data in tracks 1203.

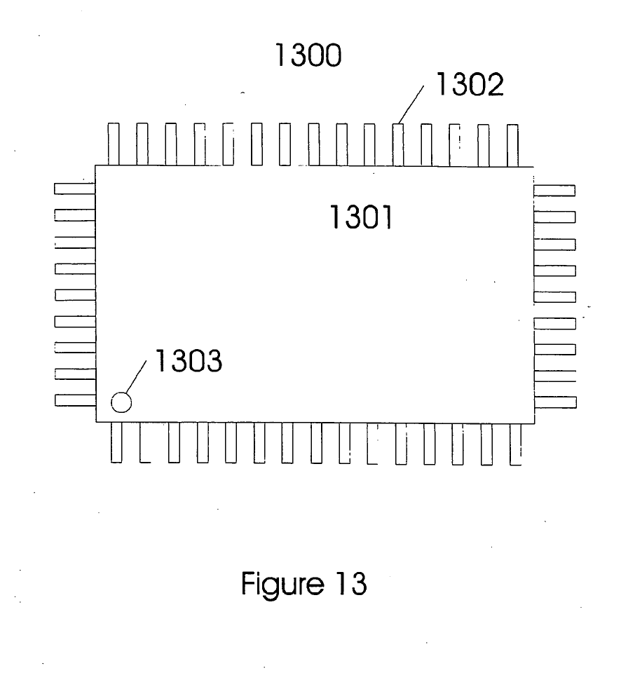

FIG. 13 shows computer chip 1300. Computer chip 1300 may be a RAM, EPROM, or ASIC chip, etc. The exterior of chip 1300 shows a typically square or rectangular body 1301 with a plurality of electrical connectors 1302 along the perimeter of body 1301. There is typically an alignment dot 1303 at one corner of chip 1300 to assist with the proper alignment of chip 1300 on a card. Within body 1301, chip 1300 consists of a number of interconnected electrical elements, such as transistors, resistors, and diodes. These interconnected electrical elements are fabricated on a single chip of silicon crystal or other semiconductor material such as gallium arsenide (GaAs) by use of photolithography. One complete layering-sequence in the photolithography process is to deposit a layer of material on the chip, coat it with photoresist, etch away the photoresist where the deposited material is not desired, remove the undesirable deposited material which is no longer protected by the photoresist, and then remove the photoresist where the deposited material is desired. By many such photolithography layering-sequences, very-large-scale integration (VLSI) can result in tens of thousands of electrical elements on a single chip. Ultra-large-scale integration (ULSI) can result in a hundred thousand electrical elements on a single chip.

While the invention has been shown and described with reference to a particular embodiment thereof, it will be understood to those skilled in the art, that various changes in form and details may be made therein without departing from the spirit and scope of the invention.

Having described my invention in such terms as to enable those of skill in the art to understand and use it, and having described the presently preferred embodiments and best mode thereof, I Claim:

1. An apparatus for an integrated system for gathering commerce information and distributing advertising using a global computer network comprised of: an electronic billboard comprised of:
a video display;
a still image display;
a cash register;
a main computer, said main computer is connected to a global computer network, said electronic billboard and said cash register are connected to said main computer;
a server connected to said global computer network, said main computer can communicate with said server through said global computer network;
a commerce sales data base, said commerce sales database stored on said server, said cash register gathers a commerce sales information, said cash register transfers said commerce sales information to said main computer, said main computer transfers said commerce sales information to said server, said server stores said commerce sales information in said commerce sales database;
an electronic billboard database, said electronic billboard database stored on said server; and
an advertisement stored as a digital file, said digital file is uploaded to said main computer through said global computer network, said main computer transfers said digital file to said electronic billboard for display.

2. A method of selecting and displaying an advertisement, comprised of the steps of: gathering a sales data on a product using a cash register; compiling said sales data into a customer purchase record; accessing a global computer network; transferring said sales data to a main computer; compiling said sales data into a commerce sales database; selecting a product based upon said commerce sales database; designing an advertisement for said product; preparing a product profile for said product; accessing an electronic billboard database; searching said electronic billboard database for an available electronic billboard; purchasing a block of advertising time to display said product advertisement on said electronic billboard; compiling said advertisement and said product profile into a single digital file; uploading said digital file through said global computer network to said main computer; transferring said digital file from said main computer to a communication server; transmitting said digital file with said communication server; receiving said digital file at an electronic billboard server; accessing said customer purchase record; comparing said customer purchase record to said product profile; and displaying said digital file on a display electrically connected to said billboard computer.

3. An apparatus for an integrated system for gathering commerce information and distributing advertising using a global computer network comprised of: an electronic billboard comprised of:
a video display;
an image display;
a cash register;
a main computer, said main computer is connected to a global computer network, said electronic billboard and said cash register are connected to said main computer;
a server connected to said main computer to communicate with said main computer;
a commerce sales data base, said commerce sales database stored on said server, said cash register gathers a commerce sales information, said cash register transfers said commerce sales information to said main computer, said main computer transfers said commerce sales information to said server, said server stores said commerce sales information in said commerce sales database;
an electronic billboard database stored on at least one of said server and said main computer; and
an advertisement stored on at least one of said server and said main computer.
